(19) United States
(12) Patent Application Publication
(10) Pub. No.: US 2022/0114328 A1
(43) Pub. Date: Apr. 14, 2022

(54) DYNAMIC PROJECT VIEWS OF A VIRTUAL WORKSPACE TO FACILITATE ACTIVE READING

(71) Applicant: LiquidText, Inc., South Salem, NY (US)

(72) Inventor: Craig Tashman, South Salem, NY (US)

(21) Appl. No.: 17/497,438

(22) Filed: Oct. 8, 2021

Related U.S. Application Data
(60) Provisional application No. 63/089,813, filed on Oct. 9, 2020.

(51) Int. Cl. G06F 40/117; G06F 40/169; G06F 9/451

(52) U.S. Cl. CPC G06F 40/117; G06F 9/453; G06F 40/169

(57) ABSTRACT

Various embodiments of this disclosure relate to digital documents and, more particularly, to facilitating active reading of one or more digital documents by creating dynamic project views of a virtual workspace. A virtual workspace includes a document and document objects associated with the document, where each document object can relate to a respective portion of the document. According to a method, a document object is tagged with a tag including a first value selected from a first category. A request is received for an automated arrangement of the document objects by the first category. The document object is assigned a first coordinate in a dimension of the virtual workspace, where the first coordinate is computed based on the first value in the tag. Based on the request, the document object is automatically repositioned within the virtual workspace to the first coordinate in the dimension.

### CROSS-REFERENCE TO RELATED APPLICATIONS

This claims the benefit and priority under 35 U.S.C. 119(e) of U.S. Provisional Application No. 63/089,813, filed Oct. 9, 2020, and titled “Dynamic Project Views of a Virtual Workspace to Facilitate Active Reading,” the contents of which are herein incorporated by reference as if set out below.

### TECHNICAL FIELD

Various embodiments of this disclosure relate to digital documents and, more particularly, to facilitating active reading of one or more digital documents by creating dynamic project views of a virtual workspace, where such a virtual workspace can include a variety of document objects based on the one or more digital documents.

### BACKGROUND

From magazines and novels to the review of important documents, reading forms a critical part of human lives, and many reading tasks involve a rich interaction with text. This rich interaction, known as active reading, can be conducted to answer questions, perform analysis, or obtain information. Active reading may involve highlighting, annotating, outlining, note taking, comparing, or searching. As a result, active reading generally demands more of a reading medium than simply an ability to advance pages.

Although paper supports bimanual interaction and freeform annotation within the boundaries of a single page, paper lacks the flexibility to provide, for example, content rearrangement, document overviews, and annotation outside of page boundaries. Additionally, although the tangibility of paper supports some rapid forms of navigation, such as through dog-earing and bookmarking with a finger, paper provides little flexibility to create a customized navigational structure. Modern pen-based computerized tablets do a fine job of imitating paper, which benefits users by providing a familiar medium, but as a result, these pen-based computerized tablets suffer from the same limitations as does paper.

### SUMMARY

Briefly described, various embodiments of this disclosure are document-processing systems and methods for facilitating active reading of documents, by providing a fluid-like interface with advantages over physical paper and conventional word processing systems. According to embodiments of this disclosure, a document-processing system may provide a novel approach to representing and interacting with documents. In contrast to the paper model, which offers a stable but rigid representation, the document-processing system may provide a highly flexible, malleable document representation. The document-processing system may provide high degree of freedom in the available manners to navigate through and manipulate a document representation, control what document content is displayed and where, and create annotations and other structures related to the document. To this end, the document-processing system may provide a multi-touch, gesture-based user interface.

Active reading involves four core processes: annotation, content extraction, navigation, and layout. Embodiments of the document-processing system may provide improvements, as compared to paper and conventional word processing, to one or more of these processes. More specifically, in some embodiments, a document-processing system includes a virtual workspace, a document view region, a preview region, and document objects (i.e., objects extracted from or otherwise related to the document and viewable in the virtual workspace). Further, the document-processing system provides dynamic views of such document objects, which enable a user to manipulate the various document objects in useful or enlightening ways during active reading.

The virtual workspace may be a working environment in which the user can review a document. The virtual workspace may be, for example, a graphical user interface displayed in a virtual window or frame viewable through a multi-touch display. In some embodiments, the virtual workspace may be designed to look and feel like a physical desktop or other physical workspace to which the user may be accustomed. The virtual workspace may be a relatively unstructured environment, enabling users to place document objects as desired throughout the virtual workspace.

The document objects may be moveable objects positioned throughout the virtual workspace as desired by the user. A document object may be created by the user to assist the user in actively reading of the document. For example, the user may create an excerpt of the document or may create an annotation, either of which may be encapsulated in a document object, which may be smaller and more easily manipulable than the document as a whole. Once created, a document object may be freely moved about the virtual workspace, so as to enable the user to arrange the virtual workspace in a manner that creates a customized active reading experience. The document object may be linked to the portion or portions of the document to which the document object relates. For example, the document object may include a visible link, such as an arrow, that the user may select (e.g., via touch) to cause the one or more documents in the document view region to shift position, thus bringing the related portions into view.

In some embodiments, a document-processing system described herein can automatically rearrange, or reposition, document objects in the virtual workspace based on tags, also referred to as labels, associated with the document objects. For instance, a document object can be associated with one or more tags, including a first tag in a first category and a second tag in a second category. The first tag has a value selected from available values in the first category, and the second tag has a value selected from available tags in the second category. Some embodiments of the document-processing system receive a selection of two categories, for instance, the first category and the second category. Based on the two categories, the document-processing system can automatically rearrange the document objects in a grid having one dimension per selected category. The review system can distribute the document objects along a first dimension based on the respective values of tags in the first category for the document objects and can further distribute the document objects along a second dimension based on the respective value of tags in the second category for the document objects. A project view, which is a current layout of the document objects within the workspace, can be saved for later recall. For instance, the document-processing system can save a manual arrangement of the document objects as a first project view and can save an automated arrangement (e.g., in a grid layout based on one or more categories) as a second project view.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION OF THE DRAWINGS

FIG. 1 is a diagram of an example of a computing system incorporating a document-processing system, according to some embodiments described herein.

FIG. 2 illustrates an example of a graphical user interface of the document-processing system, according to some embodiments described herein.

FIGS. 3A-3B illustrate creation of an excerpt object in the document-processing system, according to some embodiments described herein.

FIGS. 4A-4B illustrate creation of an annotation object in the document-processing system, according to some embodiments described herein.

FIG. 5 illustrates a virtual workspace in a project view belonging to a project of the document-processing system, according to some embodiments described herein.

FIG. 6 is a flow diagram of a process for tagging a document object, according to some embodiments described herein.

FIG. 7 illustrates an example of the virtual workspace of FIG. 5 according to another project view of the project, according to some embodiments described herein.

FIG. 8 is a flow diagram of a process for tagging a document object, according to some embodiments described herein.

FIG. 9 is another diagram of an example of a computing system that can perform certain operations of the document-processing system, according to some embodiments described herein.

### DETAILED DESCRIPTION

To facilitate an understanding of the principles and features of this disclosure, various illustrative embodiments are explained below. In particular, embodiments of this disclosure are described in the context of being a document-processing system enabling a user to interact with documents in a fluid-like environment, thus facilitating active reading. Embodiments of this disclosure, however, are not limited to this context. Rather, some embodiments may provide a freeform, fluid-like environment for performing a variety of tasks.

The document-processing system may improve one or more of four major processes that occur in active reading, specifically annotation, content extraction, navigation, and layout, and may also provide features for analyzing how these processes are applied to specific documents. Annotation is defined as text embellishment, including highlighting and marginalia. The document-processing system may provide efficient annotation by enabling convenient switching between annotation tools, by supporting idiosyncratic markings, and by providing a convenient means for retrieving annotations made previously. Content extraction generally includes copying or moving content from a document to a secondary location, such as when outlining or note taking. In some embodiments, the document-processing system may closely integrate extraction with the reading process, so the user can organize and view extracted content, as well as link extracted content back to the original document. Navigation generally entails moving throughout a document and between multiple documents, such as when searching for text, turning a page, or flipping between selected locations for comparison. The document-processing system may support bookmarks and parallelism to facilitate these or other navigational tasks. Layout generally refers to the visual or spatial arrangement of the document. The document-processing system may optimize layout according to the user's preferences by enabling distinct portions of the document to be viewed in parallel, while maintaining the document's linearity.

Conventional paper-like approaches fall short in facilitating these processes because of their fixed structure and lack of flexibility. Utilizing a multi-touch input device may provide parallel and bimanual input, which are important parts of paper-based reading, and which also enable a flexible environment. A mouse, as used in most computer-based reading systems, is an inefficient control device because it provides only a single indicator or selector. A keyboard, also used in most computer-based reading systems, lacks natural spatial mapping. The flexible interactions made possible by embodiments of the document-processing system inherently offer more degrees of freedom than traditionally offered by computer-based reading systems. Controlling certain interactions described herein with a mouse or a keyboard would be less efficient, requiring numerous sequential inputs to create a single command. As such, some embodiments of the document-processing system support multi-point spatial input and may thus by capable of efficiently receiving a wide array of gestures interpretable as commands.

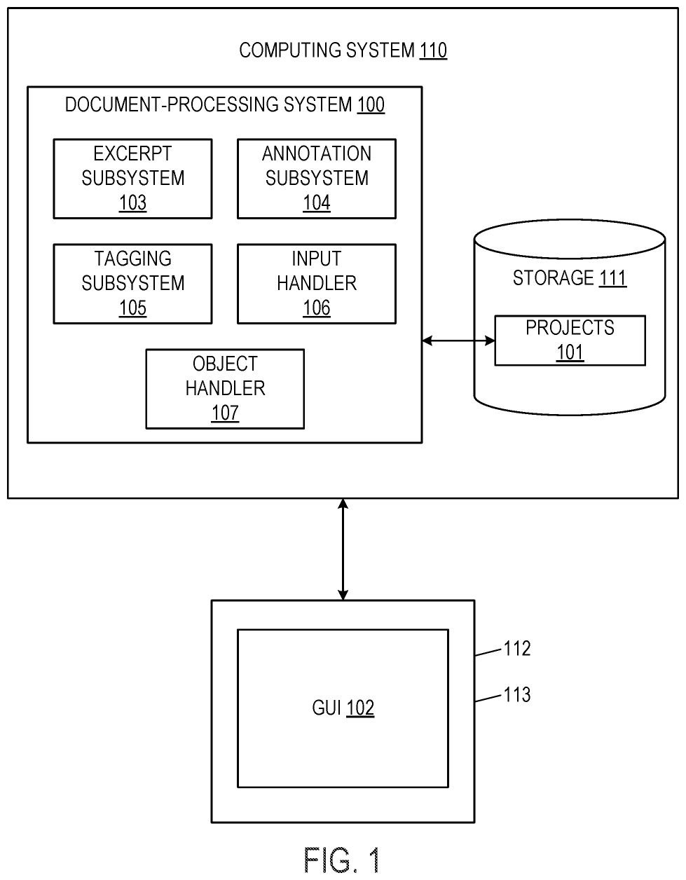

FIG. 1 is a diagram of an example of a computing system 110 incorporating a document-processing system 100, according to some embodiments described herein. The directions of the various arrows shown in FIG. 1 illustrate an example communications flow; however, these arrows are provided for illustrative purposes only and do not limit the various embodiments described herein. The embodiment depicted in FIG. 1 is merely an example and is not intended to unduly limit the scope of claimed embodiments. One of ordinary skill in the art would recognize many possible variations, alternatives, and modifications. For example, in some implementations, more or fewer systems or components than those shown in FIG. 1 may be provided, two or more systems or components may be combined, or a different configuration or arrangement of systems and components may be provided. The systems and other components depicted in FIG. 1 may be implemented in software (e.g., as program code) stored in a non-transitory storage medium and executable by one or more processing units, in hardware (e.g., as a specialized hardware circuit), or combinations thereof. Some embodiments of the document-processing system 100 may be incorporated into plugins for third-party applications. In that case, such an application may inherit one or more of the various features of standalone embodiments of the document-processing system 100.

As described in detail below, in some embodiments, the document-processing system 100 processes one or more documents to facilitate active reading by generating document objects based on a document displayed by, or otherwise accessible, to the document-processing system 100. As described in detail below, in some embodiments, a document object is a moveable object based on the document, for instance, in that the document object includes an excerpt of the document or an annotation (e.g., a comment) about the document. In some embodiments, the document-processing system 100 tags a document object with single- or multi-dimensional tags (e.g., tags associated with one or multiple categories) such that each document object can be associated with a tag selected from each category of a variety of categories. The document-processing system 100 may then automatically and dynamically arrange the document objects in a one-dimensional, two-dimensional, or other multidimensional grid within a virtual workspace of the document-processing system 100. The document-processing system 100 may save the state, or project view, of the virtual workspace, such that the document-processing system 100 can recall the state of the virtual workspace having a certain arrangement of document objects.

As shown in FIG. 1, some embodiments of the document-processing system 100 include one or more of the following subsystems: an excerpt subsystem 103, an annotation subsystem 104, a tagging subsystem 105, an input handler 106, and an object handler 107. In some embodiments, generally, the excerpt system 103 generates excerpt objects, which are a type of document object; the annotation subsystem 104 generates annotation objects, which are another type of document object; the tagging subsystem 105 generates tags for the document objects; the input handler 106 receives indications of manual inputs, such as via the input device 113, and interprets such manual inputs as requests for action related to the virtual workspace or other aspects of the GUI 102; and the object handler 107 repositions or otherwise modifies document objects as needed responsive to manual input or automated operations. Each of these subsystems may be implemented as hardware, software, or a combination of hardware and software. For instance, a subsystem may be implemented as one or more software functions or as a specialized hardware device, or a combination of both. Further, these particular subsystems are indicated herein for illustrative purposes only based on functionality. For instance, one or more subsystems can be combined into common hardware or software, a subsystem can be further divided, or the functionality described herein as attributable to a specific subsystem can be distributed through various subsystems in various manners.

In the example embodiment depicted in FIG. 1, the document-processing system 100 runs on the computing system 110, which can include one or more computing devices. For instance, the computing system 110 may be a single computing device or may be a distributed system of computing devices. For example, the document-processing system 100 may be implemented by one or more computing devices of a cloud service infrastructure. The computing system 110 can be one or more of various types, including but not limited to a consumer device such as a notebook computer, a tablet, or a smartphone a desktop computer. The document-processing system 100 may be implemented as a combination of software or hardware on the computing system 110. For instance, in an example embodiment, the document-processing system 100 is implemented as a software application that runs on the computing system 110.

The document-processing system 100 has access to storage 111 of the computing system 110. The storage 111 is, for instance, a volatile or nonvolatile storage device. In some embodiments, the storage 111 maintains projects 101 or other files accessibly by or saved by the document-processing system 100. For example, the document-processing system 100 may access a document in the storage 111 and may open that document in a virtual workspace of the document-processing system 100, such that a user can utilize features of the document-processing system 100 with respect to the document. Further, the document-processing system 100 can save to the storage 111 a project 101 of the document-processing system 100, where the project 101 can include one or more project views of a virtual workspace, and where a project 101 can include one or more categories or tags associated with document objects in the virtual workspace. In some embodiments, the document-processing system 100 saves a project 101 in a proprietary file format or in some other format.

The computing system 110 can have or can communicate with an output device 112 and an input device 113. In some embodiments, the output device 112 is in communication with the computing system 110 and, thus, with the document-processing system 100. An embodiment of the output device 112 renders or otherwise displays a graphical user interface (GUI) 102 of the document-processing system 100.

In some embodiments, a user interacts with the document-processing system 100 through the use of the input device 113. For instance, the input device 113 is a multi-touch input device, such as a multi-touch touchscreen, a multi-touch trackpad or touchpad, or some other input device that enables the user to provide gestures in the form of input, such as multi-touch input, received by the document-processing system 100. More specifically, an example of the input device 113 is a multi-touch device capable of receiving multiple simultaneous touches, thus enabling a user to interact with the document-processing system 100 in a natural manner, using multiple hands and fingers simultaneously. The input device 113 may detect user interactions with the input device 113 and may provide an indication of such user interactions to the computing system 110, which provides an indication of such user interactions to the input handler 106 of the document-processing system 100. Additionally or alternatively, the input device 113 may otherwise cause the computing system 110 to detect user interactions performed by the user with the input device 113, and the computing system 110 may thus provide an indication of such user interactions to the input handler 106 of the document-processing system 100.

These user interactions, or gestures, may be interpreted by the input handler 106 as requests to the document-processing system 100. As such, the document-processing system 100 may be configured to take as input user interactions that include one or multiple simultaneous touches through the input device 113. Additionally or alternatively to being a touch-sensitive device, the input device 113 may include some other multi-point, bimanual, or spatial input device capable of receiving gestures interpretable as requests. In some embodiments, however, the input device 113 may be a traditional mouse or keyboard, and in that case, the document-processing system 100 accesses a mapping defined to map mouse or keyboard input to gestures performable on a touchscreen input device.

As used through this disclosure, the terms “touch,” “hold,” “interaction,” and “gesture” need not refer only to physical contact between the user and the input device 113. Such terms may refer to various interactions simulating a physical contact, such as pointing from a distance or bringing an implement, such as a finger, hand, or stylus, in close proximity to the input device 113, so as to indicate a virtual touching, holding, or the like. The definition of a these terms may be implementation-dependent, such that the type of input device 113 used may determine how interactions are detected and thus how these terms are defined. In some embodiments, however, a “hold” may be a touch that spans a predefined period of time (e.g., one second), and a “gesture” or an “interaction” may be a type of touch or a combination of types of touches. For example, the input device 113 may utilize resistive, capacitive, or camera technologies. For example, if camera technology is used, then a “touch” may be defined based on camera sensitivity, or on an instrument's being within a predetermined distance from the input device 113. Additionally, “touch,” “hold,” “interaction,” “gesture” or other terms need not refer only to interactions between the user's hands or fingers and the input device 113 but may also refer to interactions with an instrument held by the user, such as a stylus, marker, or pen. Further, in cases where a mouse and keyboard are being used, it will be understood that the above terms refer to mouse and keyboard commands and command sequences that are mapped to touch-based gestures.

In the example of FIG. 1, the input device 113 and the output device 112 are the same device. In one example, that device is a touchscreen monitor in communication with the computing system 110. In another example, that device is a screen integrated with the computing system 110; for instance, the computing system 110 could be a smartphone, tablet, or notebook computer, and the input device 113 and the output device 112 could both be an integrated display. In yet another example, the computing system 110 on which the document-processing system 100 runs provides a cloud-based service, and the input device 113 and output device 112 are a consumer device utilizing the cloud-based service such that the computing system 110 causes such consumer device to display the GUI 102 and such that user input is communicated from the device back to the computing system 110.

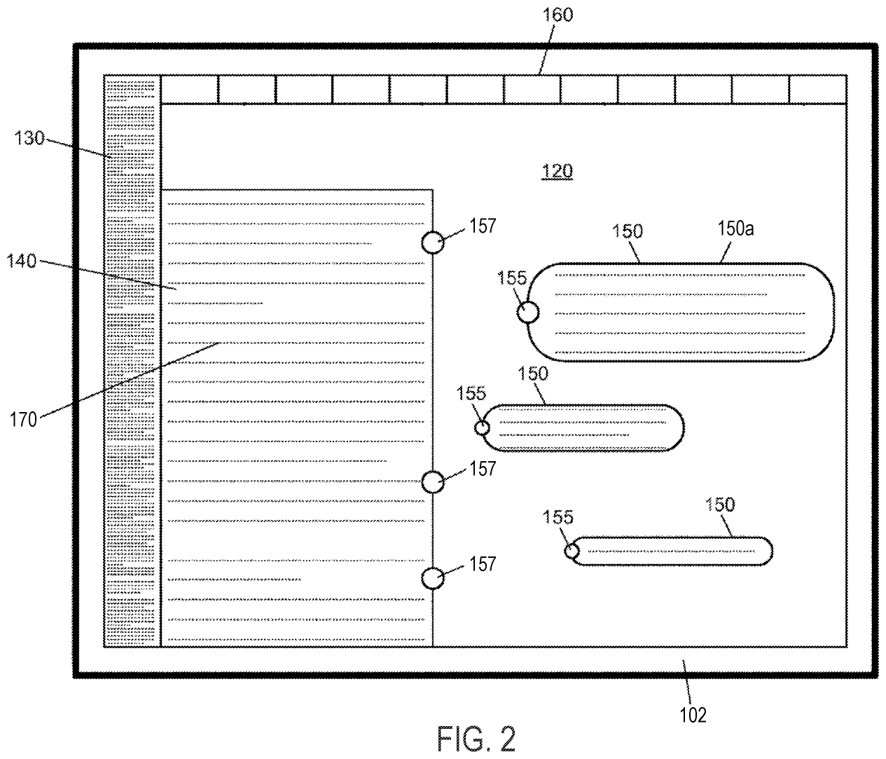

FIG. 2 illustrates an example GUI 102 of the document-processing system 100, according to some embodiments described herein. As shown in FIG. 2, the GUI 102 may include, for example, a virtual workspace 120, a preview region 130, one or more document view regions 140, one or more document objects 150, and a toolbar 160. For instance, the preview region 130, the document view region 140, and the document objects 150 may be shown inside the virtual workspace 120. In some embodiments, a user can interact with the document-processing system 100 by performing a gesture (e.g., a touch gesture) that involves touching, with one or more fingers or styli, an aspect of the GUI 102. The document-processing system 100 can interpret such gesture as a request for some action to be taken, as described further below.

The virtual workspace 120 may simulate a physical desktop, in that the user may freely move document objects 150 throughout the virtual workspace 120 without being bound by a fixed structure (e.g., a page boundary) common in computer-based reading system. In some embodiments, the virtual workspace 120 may further include a preview region 130 or a document view region 140 shown in the GUI 102. In other embodiments, however, the virtual workspace 120 may be defined as the useable space of the GUI 102 outside of the toolbar, the preview region 130, and the document view region 140.

When an application embodying the document-processing system 100 is first opened, the document-processing system 100 may present the user with the virtual workspace 120 that shows a document 170 or is configured to display a yet-to-be-opened document 170. The user may control the document 170 and other document objects 150 in the virtual workspace 120 with a vocabulary of gestures, such as multi-touch gestures. Through these gestures, the user may navigate, annotate, or manipulate the virtual workspace 120, potentially without having to explicitly select tools or otherwise shift attention away from the document 170 displayed. For example, objects may be repositioned by dragging the objects about the virtual workspace 120. Rescaling may be performed by a pinching or stretching gesture with two fingers, such as in a horizontal orientation. Some embodiments additionally or alternatively implement gestures that are unconventional.

The user may open a document 170 in the virtual workspace 120, and the open document 170 may be displayed in the one or both of the preview region 130 or a corresponding document view region 140. Throughout this disclosure, various actions are described as being performed or performable on the text of the open document 170, document object 150, or other component. It will be understood, however, that some or all of such actions may similarly be performed on data that is not text, such as images or multimedia. Thus, the term “text” throughout this disclosure is used for illustrative purposes only and is not restrictive.

The preview region 130 may be configured to display the document 170 at a magnification or size that enables the user to view the general layout of the document 170. In some embodiments, the entire document 170 may be viewable in the preview region 130, so as to present the general layout of the entire document 170 to the user. Thus, the preview region 130 may display the document 170 at a lower magnification level (i.e., smaller) than the document 170 appears in the document view region 140. In some embodiments, however, the document-processing system 100 enables magnification of the preview region 130, such that the user may select a magnification size that is best suited to the user's needs.

The document view region 140 may display at least a portion of the open document 170. In some embodiments, the document view region 140 may display the document 170 at a magnification or size enabling the user to easily read the text of the document 170. In a further embodiment, the document-processing system 100 enables the magnification of the document 170 in the document view region 140 to be modified by the user and thus enables the user to select a text size best suiting the user's needs.

In some embodiments, more than a single document view region 140 may be provided in the virtual workspace 120 at a time, where each document view region 140 may display at least a portion of a corresponding document 170. In other words, multiple documents 170 may be visible at once, with a first document 170 displayed in a first document view region 140 and a second document 170 displayed in a second document view region 140.

The text of the document 170 may, in either or both of the preview region 130 and the corresponding document view region 140, be presented to the user in a continuous format, with or without pagination. If pagination is provided, then this provision may be for the user's reference only and need not restrict operations of the document-processing system 100 to page boundaries. Some embodiments of the document-processing system 100 may enable the user to select whether pagination is shown, to further customize the user's active reading experience.

As mentioned above, the document-processing system 100 may provide document objects 150 in the virtual workspace 120. Document objects 150 may be objects created by the user for various reasons, such as to facilitate the user's active reading process. For example, a particular document object 150 may be created by the document-processing system 100, specifically, for instance by the excerpt subsystem 103 or the annotation subsystem 104, at the request of a user to represent and include an excerpt or annotation of one or more documents 170. For instance, the excerpt subsystem 103 may create an excerpt object, which is a document object 150 that includes a portion, or excerpt, of the document 1700; the annotation subsystem 104 may create an annotation object, which is a document object 150 that includes a comment or other annotation related to the document 1700, where that comment may have been written or otherwise provided by the user.

The appearance of a document object 150 may vary based on implementation. In some embodiments, as shown in FIG. 2, a document object 150 may have a rectangular shape with curved corners and may include text or other information inside the outline of that shape. Additionally or alternatively, however, document objects 150 can have other shapes, such as circular, elliptical or freeform. In some embodiments, a document object 150 has a default size; however, the document-processing system 100 may modify the size or shape of a document object 150 based on a request made via user input or based on other factors, such as the size or shape of information be displayed in the document object 150.

In some embodiments, the virtual workspace 120 may include one or multiple document objects 150 associated with a document 170 or may include document objects 150 associated with multiple documents 1700, such that a first document object 150 in the virtual workspace 120 is associated with a first document 170 while a second document object 50 in the virtual workspace 120 is associated with a second document 170. Each document object 150 may include text, an image, multimedia content such as a video, or another annotation or portion of the document 170.

A document object 150 may include a source link 155 to a portion of a document 170 with which the document object 150 is associated, where the document object 150 specifically relates to the portion to which the source link 155 refers. Further, in the case of a document object 150 related to portions of one or more documents 170, that document object 150 may include a respective source link 155 referring to each such portion of those two or more documents 170. For instance, in the case of an excerpt object, the source link 155 in the excerpt object may refer to, and thus link to, a portion of the document 1700 from which an excerpt of the excerpt object was extracted. In the case of an annotation object, the source link 155 in the annotation object may refer to, and thus link to, a portion of the document 1700 being annotated by information in the annotation object.

A source link 155 may have a visible representation, such as an arrow, which may point from the document object 150 to the document view region 140 to indicate that the referred-to portion of the document 170 could be displayed in the document view region 140. When the user selects the source link 155, the document 170 in the document view region 140 may automatically highlight, or emphasize, the portion of the document 170 referred to by the document object 150. Selection of the source link 155 may occur, for instance, when the user touches the visible representation of the source link 155. Highlighting can take various forms. For example, if the referred-to portion is visible in the document view region 140, the document-processing system 100 may highlight that referred-to portion by changing the color of a region surrounding that portion. For another example, to highlight the portion, the document-processing system 100 may cause the document 170 in the document view region 140 to scroll to bring the referred-to portion of the document 170 into view. For yet another example, selecting the source link 155 may cause the referred-to portion to be centered within the document view region 140, thus highlighting the referred-to portion.

In some embodiments, in the document view region 140, the portion of the document 170 being referred to by a source link 155 of a document object 150 may analogously include a destination link 157, referring back to the document object 150 doing the referring. Like the source link 155 in the document object 150, the destination link 157 in the document view region 140 may have a graphical representation, such as an arrow. This arrow may be positioned on or near the relevant portion of the document 170 as displayed in the document view region 140. When the destination link 157 is selected, the document-processing system 100 may emphasize the document object 150 in the virtual workspace 120 to enable the user to locate the document object 150 in the virtual workspace. Emphasis may take various forms. For example, the document object 150 may automatically be placed on top of other document objects 150 that appear in the virtual workspace 120 and that might have blocked the user's view of that document object 150. Additionally or alternatively, for example, the document object 150 may flash, change color, or be emphasized in various other manners to enable the user to locate the document object 150 as a result of the user's selection of the destination link 157 within the document 170.

As mentioned above, selecting a source link 155 of a first document object 150 may cause the related portion (i.e., the referred-to portion) of the document 170 to be emphasized in the document view region 140. Alternatively, however, if the source link 155 connects to a second document object 150, as will be described further below, then when the source link 155 is selected, the document-processing system 100 may emphasize that second document object 150, for instance, in such a way that the document object 150 and the second document object 150 can be viewed simultaneously in the virtual workspace (e.g., such that one is not on top of the other). In some embodiments, a source link 155 may refer to more than a single portion of a document 170 or to more than a single document object 150. If multiple portions of information in one or more documents 170 or in other document objects 150 are referred to by a selected source link 155, or if multiple source links 155 of the first document object 150 are selected, or if multiple source links 155 of multiple document objects 150 are selected, then the document 170 in the document view region 140 may collapse (i.e., reduce the size or spacing between certain lines of text between relevant portions), scroll, or collapse and scroll as needed to simultaneously display all portions of the document 170 and document objects 150 referred to by the selected source links 155. Thus, the document-processing system 100 may establish sets of bidirectional referral links, with each set including at least one source link 155 acting as a referral link of the document object 150 to the document 170 and at least one destination link 157 acting as a referral link of the document 170 to the document object 150. The bidirectional referral links enable the user to maintain a connection between portions of the document 170 and related document objects 150 and, further, to recall portions of documents 1700 or document objects 150 as desired.

As mentioned above, some embodiments of the document-processing system 100 may enable some document objects 150 to refer back to other document objects 150. In other words, a second document object 150 may be created to refer to an existing first document object 150. In that case, the second document object 150 may include a source link 155 referring back to the first document object 150, which represents the source referred to by the second document object 150. The first document object 150 may include a destination link 157 referring back to the second document object.

In some further embodiments, a document object 150 may be created based on two or more existing document objects 150. For example, an annotation object may be created to comment on a relationship between an existing first document object 150 and an existing second document object 150. Various mechanisms may be provided for the user to initiate creation of such an annotation object, or other type of third document object 150 based on one or more existing document objects 150. For example, the user may select one or more existing document objects 150, such as by tapping them in the virtual workspace 120. When a selection is made, the document-processing system 100 may provide a “comment” button, menu bar, or other option enabling the user to indicate his desire to comment on the selected one or more document objects 150. After the user indicates this desire, such as by selecting the “comment” button, the document-processing system 100 may create a new annotation object, which may have initially empty comment text, which the user can fill by typing a comment or inserting other information.

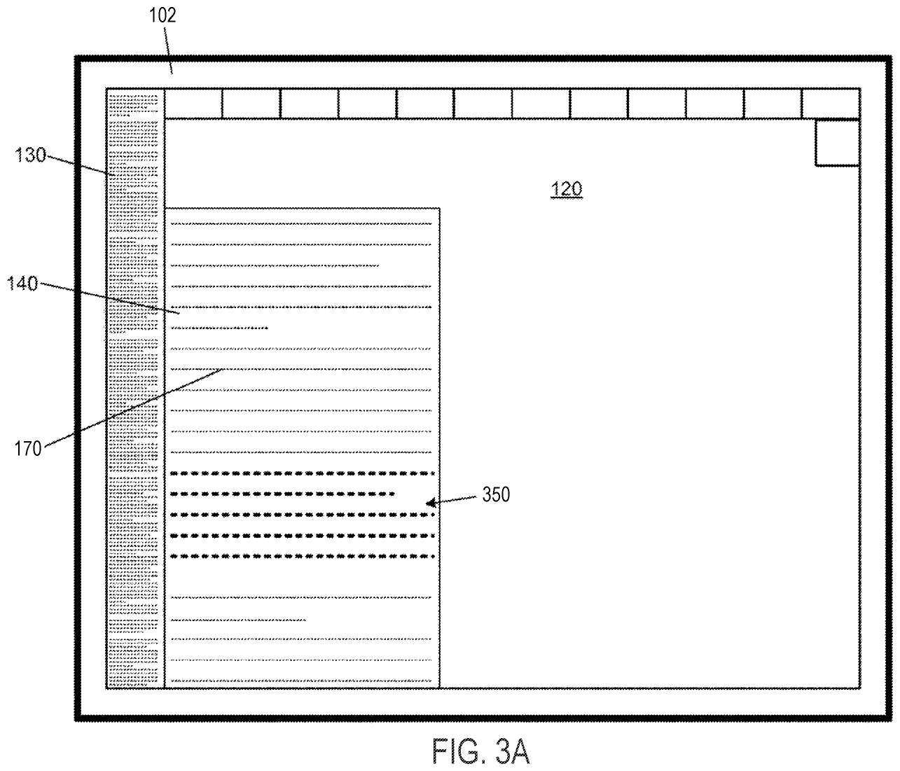

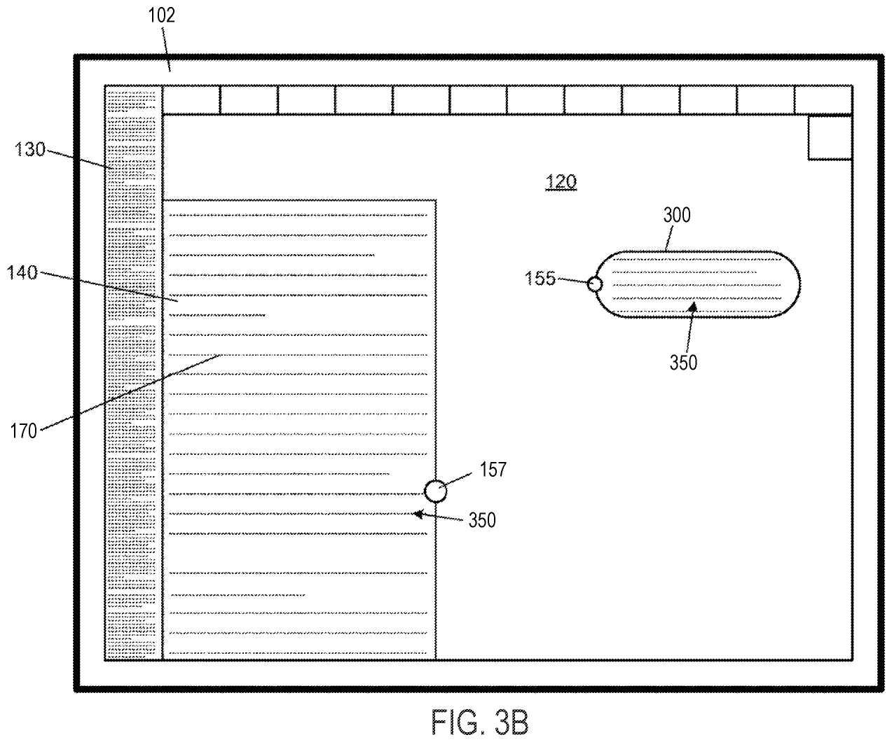

FIGS. 3A-3B illustrate creation of an excerpt object 300 in the document-processing system 100, according to some embodiments described herein. More specifically, FIG. 3A illustrates a selected portion of information (i.e., an excerpt 350) within the document 170, and FIG. 3B illustrates the virtual workspace 120 after the selected portion has been extracted into an excerpt object 300. In some embodiments, the excerpt subsystem 103 of the document-processing system 100 generates excerpt objects 300 as described below or otherwise.

The document-processing system 100 can create an excerpt object 300 in response to an excerpt gesture, which can include a selection gesture in combination with an extraction gesture. To perform the excerpt gesture, the user can perform touch and hold the document 170 in the document view region 140 with one finger or hand, can then perform the selection gesture by touching a portion of the document 170 to be extracted so as to select that portion, and can then perform the extraction gesture by dragging from the selected portion of the document 170 in the document view region 140 into a part of the virtual workspace 120 outside of the document view region 140. This can be an intuitive gesture, because performing the gesture simply requires the user, before or after initial selection, to simulate holding the document 170 in place with one hand, while dragging a portion of the document 170 away with the other hand.

Once created, an excerpt object 300 can be moveable throughout the virtual workspace 120. The excerpt object 300 can include an excerpt 350, such as the text or other information extracted from the document 170 during the excerpt object's creation. In an embodiment, this excerpt 350 is not removed from the document 170 in the document view region 140, but is simply duplicated into the excerpt object 300 for the user's convenience, while maintaining the linearity and content of the document 170 in the document view region 140.

The excerpt object 300 can include a source link 155 back to the portion of the document 170 from which it was extracted. That source link 155 can have a graphical representation, such as an arrow, visible on or near the excerpt object 300 in the virtual workspace 120. When the user selects the source link 155, such as by touching the graphical representation, the document view region 140 can automatically return to the portion of the document 170 referred to by the excerpt object 300. In other words, if the document view region 140 no longer displays the section of the document 170 from which the excerpt 350 in the excerpt object 300 was extracted, that section of the document 170 can automatically become viewable (e.g., centered) in the document view region 140 when the user selects the arrow or other representation of the source link 155 in the excerpt object 300. Thus, the user can retrieve the portion of the document 170 referred to by an excerpt object 300 by simply selecting the source link 155 of the excerpt object 300.

In the document view region 140, the portion of the document 170 that was extracted to the excerpt object 300 can include a destination link 157 to the excerpt object 300. Like the source link 155 included in the excerpt object 300, the destination link 157 in the document view region 140 can have a graphical representation, such as an arrow. This arrow can be positioned on or near the extracted portion of the document 170 in the document view region 140. When the destination link 157 is selected, the document-processing system 100 can emphasize the excerpt object 300 referred to by the destination link 157 to enable the user to locate the excerpt object 300. Emphasis can take various forms. For example, the excerpt object 300 can automatically be placed in front of other document objects 150 that may appear in the virtual workspace 120 and that may block the user's view of the excerpt object 300. Alternatively, for example, the excerpt object 300 can flash, change colors, or be emphasized in various other manner to enable the user to locate the excerpt object 300 as a result of the user's selection of the destination link 157 within the document 170. Thus, when an excerpt object 300 is created, the document-processing system 100 can establish a pair of bidirectional links enabling the user to maintain a connection between the excerpt object 300 and the portion of the document 170 from which the excerpt 350 in the excerpt object 300 was extracted.

A large shortcoming of paper is the constraint that paper places on textual annotations, such as comments and notes. Annotations on paper must generally fit to the space of a small margin, and are typically only able to refer to text appearing within a single page. While software products like Microsoft Word® and Adobe Acrobat® avoid some of these difficulties, these software products still largely follow paper's paradigm. As a result, annotations created by these software products are thus limited to a single referent on a single page, and the user is provided little control over the size and scale of annotations. The document-processing system 100 can overcome these difficulties by providing a flexible visual-spatial arrangement.

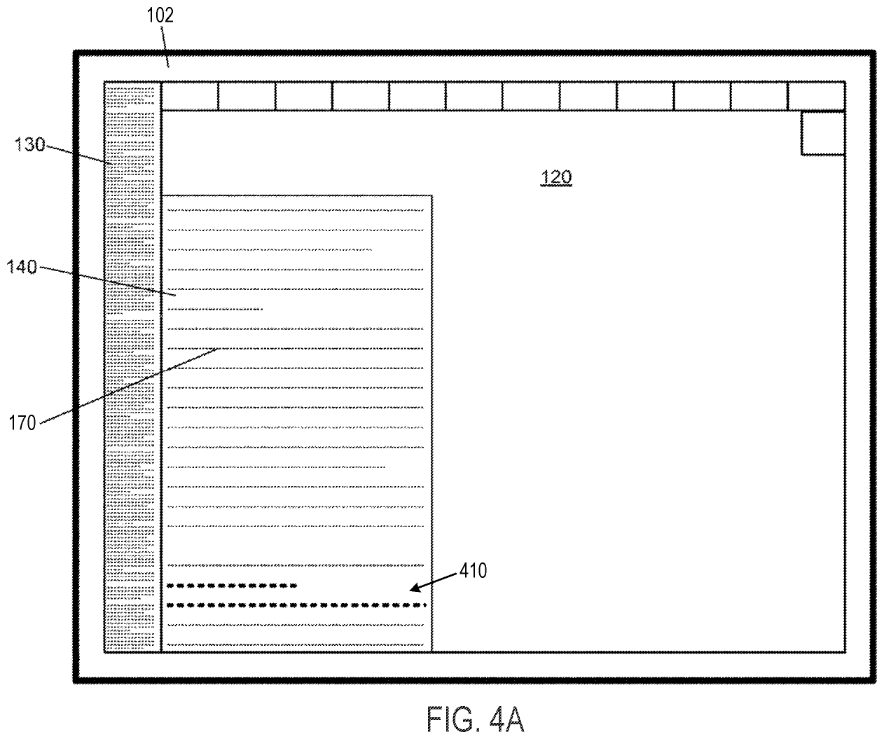

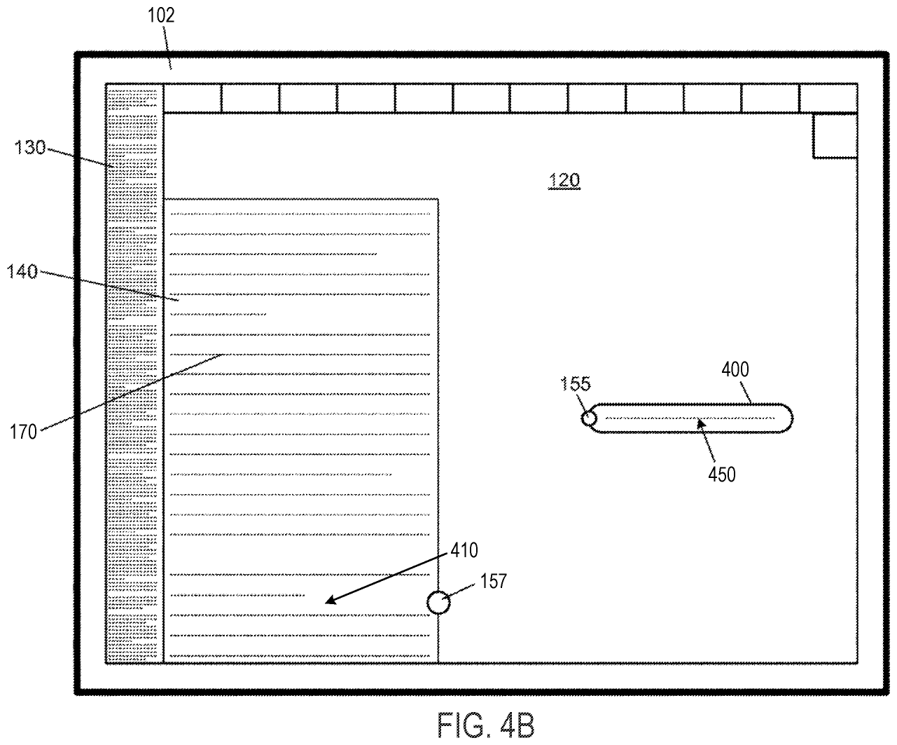

FIGS. 4A-4B illustrate creation of an annotation object 400 in the document-processing system 100, according to some embodiments described herein. More specifically, FIG. 4A illustrates selection of information 410 in the document 170 to which an annotation object 400 will refer, and FIG. 4B illustrates an annotation object 400 referring back to the information selected in FIG. 4A. In some embodiments, the annotation subsystem 104 of the document-processing system 100 generates annotation objects 400 as described below or otherwise.

In some embodiments, creation of an annotation object 400 in the document-processing system 100 can begin with selection of information 410 such as text in the document 170, as displayed in the document view region 140, or with selection of information in a preexisting document object 150. After the information 410 is selected, the user can simply begin typing, or the user can select an annotation button and then begin typing or otherwise providing input. The document-processing system 100 can then interpret the input as an annotation 450, which can be encapsulated in an annotation object 400, which is a type of document object 150. The annotation 450 received from the user can be displayed in the annotation object 400.

In some embodiments, the annotation object 400 need not refer to only a single portion of information 410 in the document 170 or in another document object 150. For example, an annotation object 400 referring to multiple portions can be created when the user selects two or more portions of information 410, using a multiple selection gesture (e.g., by touching and holding two portions with different hands, fingers, or implements), and then types or otherwise provides (e.g., by pasting) the annotation 450. For another example, an annotation object 400 can be created for multiple portions of information 410 by touching and holding each intended section within the preview region 130, within the document view region 140, within one or more document objects 150, or some combination of these, and then typing or selecting an annotation button.

The annotation object 400 can have various similarities to an excerpt object 300, given that both are types of document objects 150. For example, as with an excerpt object 300, the document-processing system 100 can create a bidirectional link between each annotation object 400 and the portion or portions of information 410 referred to by the annotation object 400. The annotation object 400 can thus include a source link 155 back to the one or more portions of the document 170 or other document objects 150 to which the annotation object 400 refers. That source link 155 can have a graphical representation, such as an arrow, and can link the annotation object 400 back to the portions of information 410 to which the annotation object 400 refers. In some embodiments, the annotation object 400 can have a respective source link 155 referring to each portion of information 410 to which the annotation object 400 refers, while in other embodiments, a single source link 155 can be used to refer back to all of the portions of information 410 in the document 170, in other document objects 150, or elsewhere. When a single source link 155 is used, and when the user selects the single source link 155 of the annotation object 400, the document-processing system 100 can cause the document 170 to automatically collapse to simultaneously display portions of information 410 in the document 170, if any, linked to the annotation object 400, and the document-processing system 100 can cause information 410 in document objects 150, if any, linked to the annotation object 400 to automatically move into view in front of other document objects 150 in the virtual workspace 120. Likewise, if multiple source links 155 are used, the user can touch and hold multiple source links 155 of an annotation object 400 to prompt the document-processing system 100 to collapse the document 170 or recall the linked document objects 150 (i.e., the document objects 150 with linked information 410), as needed to display the multiple linked portions of information 410 referred to by the source links 155.

Document objects 150, such as excerpt objects 300 and annotation objects 400, can be located in the virtual workspace 120, and the document-processing system 100 can enable the document objects 150 to be manipulable in a manner similar to physical objects in a physical workspace. For example, a document object 150 can be freely moved about the virtual workspace 120 and positioned in the workspace 120 wherever the user desires. Document objects 150 can be placed over one another, so as to hide each other or to bring one document object 150 into view at the expense of the visibility of another document object 150. The size and number of document objects 150 that can be placed on the virtual workspace 120 need not have a predetermined limit, so the user can create and manipulate as many document objects 150 as the user desires to fit into the virtual workspace 120 in some embodiments.

In some embodiments, the document-processing system 100 can recognize a resizing gesture, such as a pinching gesture, for modifying the size of an individual document object 150. The user may desire to selectively and temporarily enlarge or shrink individual or groups of document objects 150 in the virtual workspace 120, as shown by an example enlarged document object 150a in FIG. 2. The document-processing system 100 can selectively enlarge or shrink one or more individual document objects 150 in response to the user's performance of the resizing gesture on the individual document objects 150.

As discussed above with respect to excerpt objects 300 and annotation objects 400, a first document object 150 can include a source link 155 or source links 155 to one or more portions of the document 170 or other document objects 150 associated with the first document object 150. A source link 155 can be part of a bidirectional link, where the other part of the bidirectional link is associated with the document 170 in the document view region 140, or with another document object 150, and refers back to the first document object 150. Selecting a source link 155 of the first document object 150 can cause the document 170 in the document view region 140 to scroll, so as to position the related portion of the document 170 at the vertical center of the document view region 140. Additionally or alternatively, if the source link 155 connects to another document object 150, then when the source link 155 is selected, that other document object 150 can be automatically brought into view over other document objects 150. If multiple portions of the document 170 or other document objects 150 are referred to by a selected source link 155, or if multiple source links 155 of the first document object 150 are selected, or if multiple source links 155 of multiple document objects 150 are selected, then the document 170 in the document view region 140 can collapse, scroll, or collapse and scroll as needed to simultaneously display all portions of the document 170 referred to by the source links 155. Analogously, linked document objects 150 can also be brought into view as necessary to display the text referred to by the source links 155. Also analogously, if selected source links 155 additionally refer to portions of a second document 170 in a second document view region 140, the document-processing system 100 can also modify that second document view region 140 as needed to display the text referred to by the selected source links 155.

In addition to being moveable throughout the workspace 120, document objects 150 can also be attachable to one another, to enable the user to rearrange the document objects 150 and the virtual workspace 120 as needed. To attach two or more document objects 150 together, the user can touch and drag one document object 150 until it contacts another. The two document objects 150 can then be attached to each other, until the user touches both of them and drags them away from each other. In some embodiments, when a group of document objects 150 are attached together, moving a primary one of those attached document objects 150 can cause all of the attached document objects 150 to move together, maintaining their spatial relationships with one another. The primary document object 150 can be, for example, the document object 150 positioned at the highest point in the virtual workspace 120, as compared to the other grouped document objects 150. Thus, the user can group annotation objects 400 and excerpt objects 300 together into a group to assist the user in performing the organizational aspects of active reading. Further, even after grouping document objects 150 together, the user can continue to rearrange the virtual workspace 120 to best suit the user's needs.

In some other embodiments, document objects 150 within a group can have a parent-child hierarchy, where a primary document object 150, such as the highest positioned or the first to become a member of the group, can be a parent of a lower positioned or later-grouped document object 150. A parent document object 150 can control the movement of its child or children, such that when the user moves the parent document object 150, the child document object 150 automatically moves, thus maintaining its spatial relationship to its parent document object 150. In contrast, when a child document object 150 is moved, its parent need not follow. The same parent-child principles can apply to manipulations of document objects 150 other than repositioning. For example, resizing, and deletion can also be inherited by a child document object 150 from a parent document object 150, such that the child document object 150 can be resized, magnified, or deleted automatically along with its parent document object 150. In contrast, manipulations performed to a child document object 150 need not be inherited by a parent document object 150.

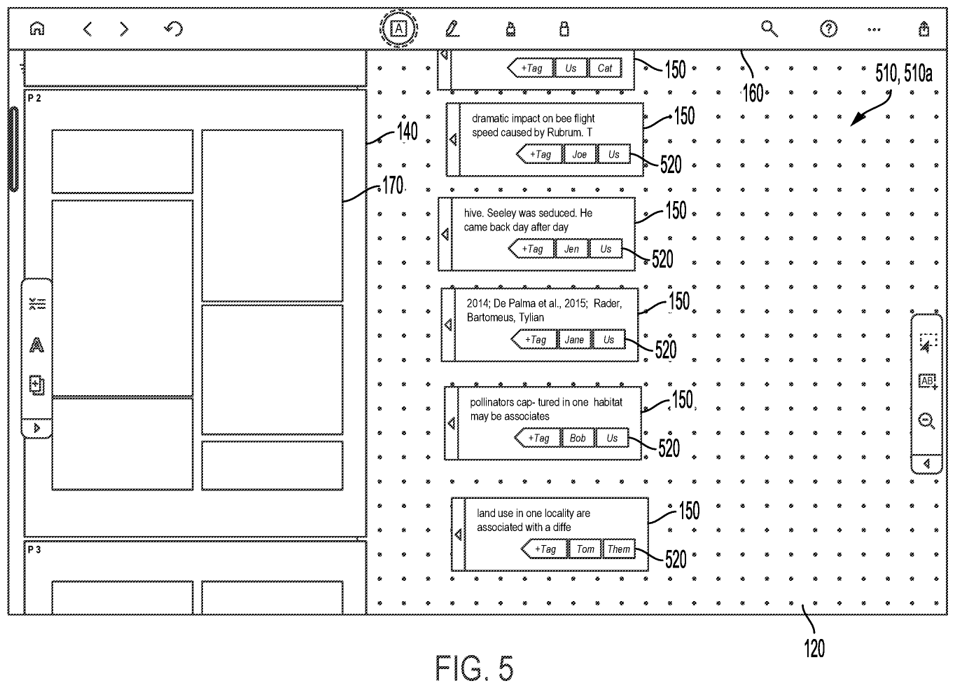

FIG. 5 illustrates a virtual workspace 120 in a project view 510, specifically a first project view 510a, belonging to a project 101 of the document-processing system 100, according to some embodiments described herein. In the example of FIG. 5, the virtual workspace 120 includes document objects 150 associated with tags 520. In some embodiments, the current state of some or all of the GUI 102, including the placements of document objects 150, is savable in a project view 510. A project 101 may include one or multiple project views 510, which the user can switch between. In the example of FIG. 5, the first project view 510a includes the virtual workspace 120 having document objects 150 positioned according to a manual arrangement. As will be described in more detail below, a project view 510 can be based on a manual arrangement or an automated arrangement, and various project views 510 can be saved in a project 101. In some embodiments, the document-processing system 100 enables the user to switch between project views 510 of a project 101 upon request.

In some embodiments, a document object 150 may be associated with one or more tags, which may include one tag per category or one or more tags per category. The document-processing system 100 may maintain a set of categories associated with a project 101, and for example, a document object 150 may be associated with up to one tag per category or up to a maximum number or an unlimited number of tags per category. The categories for a project 101 may be system defined or user defined. For instance, a user may specify a set of categories for a project 101, which the document-processing system 100 may then associate with the project 101. A document object may be associated with a set of tags. Each tag may be associated with a category, and each tag may have a value selected from the values allowed for that category. Further, in some embodiments, the tags may be color-coded.

In some embodiments, a project 101 is a set of aspects of the document-processing system 100 that are stored as a collection. For example, a project 101 includes a virtual workspace 120 including objects viewable in the virtual workspace 120, such as one or more documents 170 as displayed in one or more document view regions 140, a preview region 130, or one or more document objects 150. Additionally or alternatively, a project 101 may include one or multiple project views 510, such that the arrangement of objects in the virtual workspace 120 may differ across project views 510. Further, the project 101 can incorporate information associated with document objects 150, such as categories and tags, as described below. In some embodiments, a project 101 is stored as a file in the storage 111, and when the document-processing system 100 opens such project 101, the document-processing system 100 then displays a virtual workspace 120 in a state saved by the user in the project 101. For instance, the virtual workspace 120 is initially displayed in accordance with a project view 510 of the project 101 where that project view 510 was active the last time the project 101 was saved. When the user selects a different project view 510 of the project 101, an embodiment of the document-processing system 100 automatically rearranges objects in the virtual workspace 120 to match the locations of such objects in that different project view 510.

In the example of FIG. 5, a document object 150 has up to one tag per category, and that tag may have a value selected from a set of values available for that category. In other examples, however, a document object 150 may have multiple tags per category. In the example shown, the categories defined for tags include an author category, which indicates who created a document object 150 or, in other words, who caused the document-processing system 100 to create the document object 150. In the author category, the following values are available, where each value corresponds to someone who may have created a document object 150: Tom, Jen, Jane, Joe, Bob, and Cat. The categories further include an evidence category, which indicates whether the information in a document object 150 favors “Us” (i.e., the party using the document-processing system 100) or “Them” (i.e., some other party). As such, in this example, in the evidence category, the following values are available: Us and Them.

In some embodiments, as in this example, each value within a category is assigned a color, and a tag 520 is color coded to match the respective color of its value in its category. In other words, a tag 520 having a first value in a first category appears in a first color assigned to the first value in the first category, while another tag 520 having a second value in the first category appears in a different color assigned to that second value in the first category. The color for a value can be manually assigned by the user or assigned automatically by the document-processing system 100, or a combination of both.

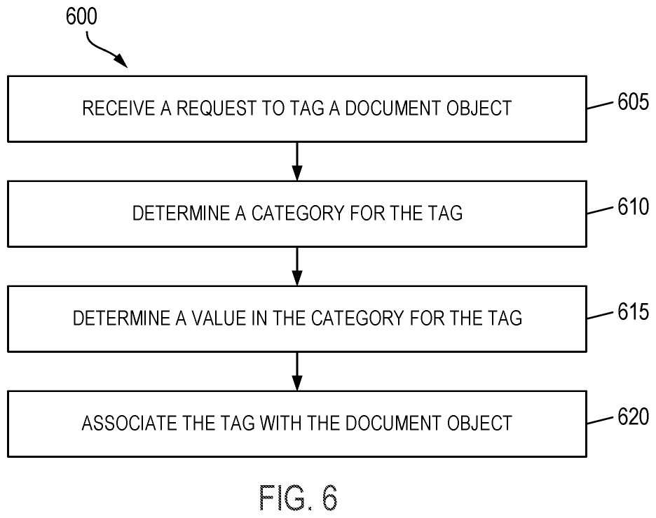

FIG. 6 is a flow diagram of a process 600 for tagging a document object 150, according to some embodiments described herein. For instance, the document-processing system 100 can perform this process 600 or similar after a document object 150 has been created to add a tag 520 to the document object 150. In some embodiments, the document-processing system 100 thus performs this process 600 or similar each time a tag 520 is to be added to a document object 150.

The process 600 depicted in FIG. 6 may be implemented in software executed by one or more processing units of a computer system, implemented in hardware, or implemented in a combination of software and hardware. The process 600 presented in FIG. 6 and described below is intended to be illustrative and non-limiting. Although FIG. 6 depicts various processing operations occurring in a particular sequence or order, this is not intended to be limiting. In certain alternative examples, the processing may be performed in a different order, some operations may be excluded or added, or some operations may be performed in parallel. Various implementations of this process 600 are within the scope of this disclosure. In certain embodiments, the below method may be performed by the document-processing system 100 and, in particular, by the tagging subsystem 103.

As shown in FIG. 6, at block 605, the document-processing system 100 receives a request to tag a document object 150 or, in other words, to create a tag 520 for the document object 150. This request can be provided to the document-processing system 100 in various manners. For example, the document-processing system 100 can provide a button on the document object 150, and the document-processing system 100 can interpret the user's selection of the button as a request to tag the document object 150. More specifically, for instance, the user can perform a touch gesture to select the button or to select some other aspect of the document object 150, such as by physically touching or pointing at the button, and the input handler 106 can interpret this selection as a request to tag the document object 150.

At block 610, responsive to the request to tag the document object 150, the document-processing system 100 determines a category to which the tag 520 being created applies. To this end, the document-processing system 100 can display an input object, such as a text box or drop-down box, enabling the user to type the name of a category or to otherwise specify a category for the tag 520. For example, the input object may be displayed in or near the toolbar 160 or in the virtual workspace 120, such as proximate to the document object 150 being tagged. In some examples, the document-processing system 100 enables the user to select an existing category or to create and select a new category for the tag 520.

At block 615, the document-processing system 100 determines a value, or label, for the tag 520. For instance, after the category is selected, the document-processing system 100 can display another input object, such as a text box or drop-down box, enabling the user to type or otherwise specify the value, or label, for the tag 520. For example, the input object may be displayed in or near the toolbar 160 or in the virtual workspace 120, such as proximate to the document object 150 being tagged. The document-processing system 100 may enable the user, by way of the input box, to select the value from available values already associated with the category or to indicate a new value, in which case the document-processing system 100 may add the new value as an available value of the category in the project 101.

At block 620, the document-processing system 100 associates the tag 520 with the document object 150, where the tag 520 belongs to the specified category and has a value equal to the specified value in that category. As such, the document-processing system 100 may display the tag 520 in the virtual workspace 120 in association with the document object 150, such as on or near the document object 150 with which the tag 520 is now associated.

In some embodiments, if the document object 150 already has a tag 520, then the value and category determined at blocks 610 and 615 are used to augment the existing tag 520, such as by adding another dimension (i.e., another category or another value in the category) to the existing tag 520, or may form a new tag 520 associated with the document object 150 in addition to the existing one. For the purposes of this disclosure, however, multiple tags 520 for a given document object 150 are treated equivalently to a multi-dimensional tag 520. Thus, operations related to a multi-dimensional tag 520 described herein can also apply to multiple separate tags 520 of the document object 150, and operations described as related to multiple separate tags 520 of a document object 150 can apply to a multi-dimensional tag 520.

Additionally or alternatively to the above, however, if categories are not being used in an embodiment, or in the particular active project 101, the document-processing system 100 can simply enable the user to specify a value, or label, for the tag 520 without identifying a category for the tag 520 as well. In that case, the document-processing system 100 may effectively use a single category for all tags 520, and in that case, at block 620, the document-processing system 100 associates the tag 520 with the document object 150 without assigning the tag 520 with any category.

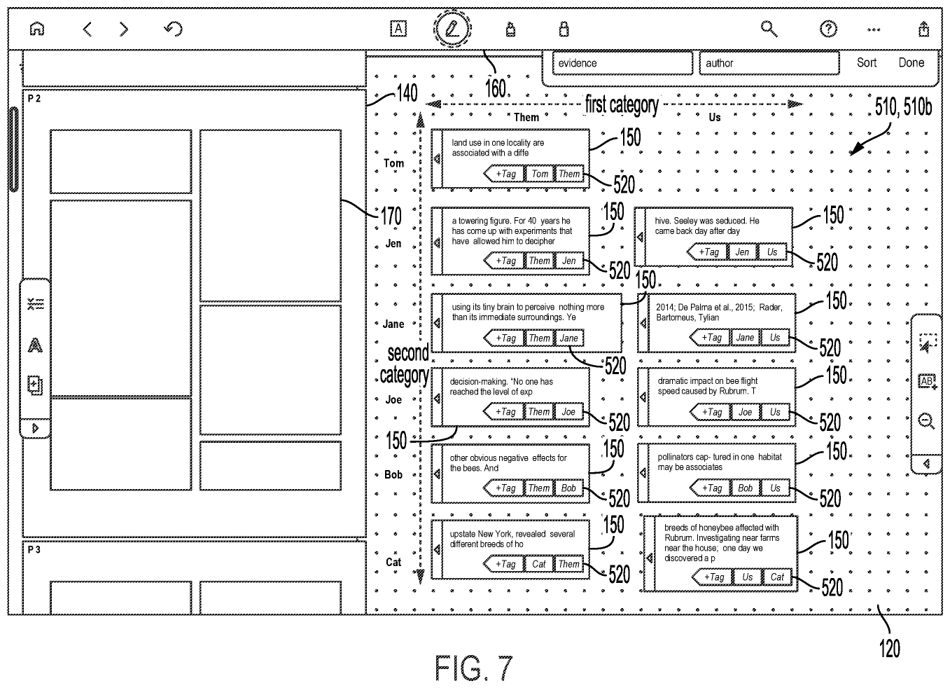

FIG. 7 shows the virtual workspace 120 of FIG. 5 according to a second project view 510b of the project 101, according to some embodiments described herein. In the example of FIG. 7, however, the project view 510b includes the document objects 150 arranged in the virtual workspace 120 according to an automated arrangement based on tags 520.

In some embodiments, the document-processing system 100 is configured to automatically rearrange, or sort, the document objects 150 by repositioning one or more document objects 150 based on the tags 520 of the document objects 150. For instance, the document-processing system 100 can automatically arrange the document objects 150 in a grid, such as a one-dimensional, two-dimensional grid, or higher-multidimensional grid, such that each dimension is associated with and represents a specific category of the tags 520.

In an example of such grid that is two-dimensional, a first dimension that extends horizontally (i.e., in the x-direction) is associated with a first category, and a second dimension that extends vertically (i.e., in the y-direction) is associated with a second category. In that case, the various values of tags 520 in the first category can be associated with horizontal positions or ranges of horizontal positions in the virtual workspace 120, and the various values of tags 520 in the second category can be associated with vertical positions or ranges of vertical positions in the virtual workspace 120. When sorting, or arranging, the document objects 150 according to the first category and the second category, an embodiment of the document-processing system 100 positions each document object 150 in a horizontal position corresponding to the value of the tag 520 of the document object 150 in the first category and in a vertical position corresponding to the value of the tag 520 of the document object 150 in the second category. As such, the document-processing system 100 assigns coordinates to each document object 150 corresponding to the values of the respective tag 520 in the first and second categories and places the document object 150 at such coordinates. Thus, when document objects 150 are automatically arranged based on the first category and the second category, the position (i.e., the coordinates) of a document object 150 are based on the values of the tags 520 in the first category and the second category.

In some embodiments, a user can modify a tag 520 of a document object 150 while that document object 150 is part of an automated arrangement based on tags 520. In some embodiments, in that case, the document-processing system 100 automatically repositions the document object 150 in the virtual workspace 120 according to the updated tag 520. In additional or alternative embodiments, however, the document-processing system 100 does not automatically reposition the document object 150 according to the updated tag 520 but, rather, performs the repositioning responsive to a request from the user to update the automated arrangement. Various implementations are within the scope of this disclosure.

In some embodiments, a category by which the document objects 150 are arranged may be time, or chronology. For instance, the document-processing system 100 may maintain a respective indication, or timestamp, of when each document object 150 was created. Thus, each document object 150 can include a tag 520, which can be system-defined and which can but need not be visually displayed on the document object 150 itself, in a time category such that the tag 520 has a value equal to the time at which the document object 150 was created. As such, when the document-processing system 100 arranges the document objects 150 according to a first category and a second category, when the first category is time, then the document-processing system 100 can place the document objects 150 according to the chronological order of their creation in one dimension (i.e., in the dimension corresponding to time).

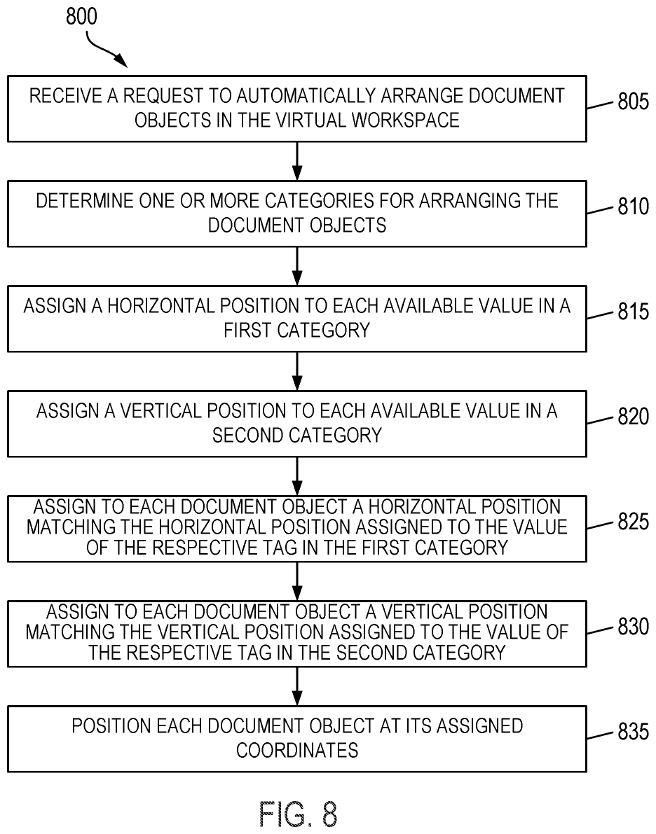

FIG. 8 is a flow diagram of a process 800 for tagging a document object 150, according to some embodiments described herein. For instance, the document-processing system 100 can perform this process 800 or similar to generate a project view 510 in which the document objects 150 are arranged according to categories.

The process 800 depicted in FIG. 8 may be implemented in software executed by one or more processing units of a computer system, implemented in hardware, or implemented in a combination of software and hardware. The process 800 presented in FIG. 8 and described below is intended to be illustrative and non-limiting. Although FIG. 8 depicts various processing operations occurring in a particular sequence or order, this is not intended to be limiting. In certain alternative examples, the processing may be performed in a different order, some operations may be excluded or added, or some operations may be performed in parallel. Various implementations of this process 800 are within the scope of this disclosure. In certain embodiments, the below process 800 may be performed by the document-processing system 100 and, in particular, by the object handler 107.

As shown in FIG. 8, at block 805, the document-processing system 100 receives a request to automatically arrange the document objects 150 based on one or more categories. In some embodiments, the request is provided by way of a touch gesture interpreted input the input handler 106. For instance, in some embodiments, the document-processing system 100 provides in the toolbar 160 or elsewhere a button labeled “Sort” or “Arrange” or otherwise labeled to indicate that the button initiates an automatic arrangement of document objects 150. Upon detecting a selection of that button, such as via a touch gesture, the input handler 106 of the document-processing system 100 interprets the selection as a request to automatically arrange the document objects 150 in the virtual workspace 120.

At block 810, responsive to the request, the document-processing system 100 determines which one or more categories to use to arrange the document objects 150 in the virtual workspace 120. To this end, for instance, the document-processing system 100 presents one or more input objects, such as text boxes or drop-down boxes, with which the user can specify one or more existing categories with which tags 520 are associated. The document-processing system 100 then receives user input through the one or more input objects and interprets such input as a first category and a second category. Although not required, one of such categories can be time (e.g., time or creation or time of last modification), for which each document object 150 can have a tag 520 with a respective value indicating the time of creation or most recent modification of the document object 150. Additionally or alternatively, the document-processing system 100 may automatically select one or more categories (i.e., default categories) to use in the absence of the user's selection of categories, or until the user selects one or more categories.

At block 815, the document-processing system assigns a corresponding horizontal position to each available value in the first category for tags 520. For instance, the document-processing system 100 identifies the available values for tags 520 of the first category and assigns a horizontal position to each such value. The horizontal position assigned to an available value can be a range of positions, where that range includes a number of pixels making up a percentage of the width of the virtual workspace 120 to be used for arranging the document objects 150; the horizontal positions of the various available values can differ from one another in some embodiments. The particular percentage can be selected to enable the various horizontal positions of the various available values to fit within the width with little or no overlap across different horizontal positions. Generally, in some embodiments, each distinct value in the first category can be assigned a unique horizontal position.

At block 820, analogously, the document-processing system assigns a vertical position to each available value in the second category for tags 520. For instance, the document-processing system 100 identifies the available values for tags 520 of the second category and assigns a vertical position to each such value. The vertical position assigned to an available value can be a range of positions, where that range includes a number of pixels making up a percentage of the height of the virtual workspace 120 to be used for arranging the document objects 150; the vertical positions of the various available values can differ from one another in some embodiments. The particular percentage can be selected to enable the various vertical positions of the various available values to fit within the height with little or no overlap across different vertical positions. Generally, in some embodiments, each distinct value in the second category can be assigned a unique vertical position.

At block 825, for each document object 150 in the virtual workspace, the document-processing system 100 assigns the document object 150 a horizontal position (i.e., a horizontal coordinate) matching the horizontal position assigned to the value of the document object's tag 520 in the first dimension. For instance, if a first value of the first category was assigned a horizontal position of X at block 815, then the document object 150 is assigned the horizontal position of X if the tag 520 of the document object 150 has that first value for the first category. If the document object 150 has no tag 520 associated with the first category, the document-processing system 100 can use a default value, such as “undefined” or can hide the document object 150. Alternatively, the document-processing system 100 can automatically apply a tag 520 associated with the first category to the document object 150, such as by considering the tags 520 that have been applied to other document objects 150 and by performing statistical inference to identify the tags 520 that would be most appropriate for the document object 150; this could be done using semantic analysis or another machine learning technique, such as one known to those skilled in the art. The document-processing system 100 can determine a horizontal position for the document object 150 by identifying the value of the document object 150 in the first category.

At block 830, for each document object 150, the document-processing system 100 assigns the document object 150 a vertical position (i.e., a vertical coordinate) matching the vertical position assigned to the value of the document object's tag 520 in the second dimension. For instance, if a first value of the second category was assigned a vertical position of Y at block 820, then the document object 150 is assigned the vertical position of Y if the tag 520 of the document object 150 has that first value for the second category. If the document object 150 has no tag 520 in the second category, the document-processing system 100 can use a default value, such as “undefined” or can hide the document object 150. Alternatively, the document-processing system 100 can automatically apply a tag 520 associated with the second category to the document object 150, such as by considering the tags 520 that have been applied to other document objects 150 and by performing statistical inference to identify the tags 520 that would be most appropriate for the document object 150; this could be done using semantic analysis or another machine learning technique, such as one known to those skilled in the art. The document-processing system 100 can determine a vertical position for the document object 150 by identifying the vertical position assigned to the value of the document object 150 in the second category.

At block 835, the document-processing system 100 then positions each document object 150 being automatically arranged in the virtual workspace 120 to the position having the coordinates of the horizontal position and the vertical position determined for the document object 150 at block 825 and 830, thereby repositioning each document object 150 as needed. The document-processing system 100 can do this for each document object 150, so as to arrange the various document objects 150 in the virtual workspace 120 based on the first and second categories. As such, for a given document object 150, the updated position after the arrangement may differ from the initial position of the document object 150 when the document-processing system 100 received the request to arrange the document objects 150. Further, in some embodiments, the document-processing system 100 may illustrate the movement of each document objects 150 from its initial position to its updated position by showing the document object's transition across intermediate coordinates between (i.e., the space between) the initial position and the updated position. This can enable the user to better understand and visualize the relationships between the initial and updated positions.

Various implementations are within the scope of this disclosure. For instance, the dimensions along which the document objects are arranged need not be horizontal and vertical but, rather, can be based on diagonal axes or other axes. Additionally or alternatively, a greater or fewer number of categories may be used to arrange the document objects 150. In such embodiments, the number of dimensions in which the document-processing system 100 arranges the document objects 150 may match the number of categories determined (e.g., selected by the user) for the automated arrangement.

As discussed above in detail, document objects 150 can include links, such as source links 155 or destination links 157, which link document objects 150 among themselves or to one or more documents 170. In some embodiments, when the document objects 150 are moved manually (i.e., as explicitly indicated by the user) or automatically, such as based on arrangement by category, these links or references in the document objects 150 are retained. For example, at the user's request, the document-processing system 100 created a bidirectional link between a first document object 150 and a second document object 150 that are right next to each other. The document-processing system 100 can then automatically rearrange the document objects 150 based on categories while maintaining this bidirectional link, and the rearrangement could position the first document object 150 and the second document object 150 on opposite sides of the virtual workspace 120. However, when the user selects a link in the first document object 150, the document-processing system 100 emphasizes the second document object 150 to remind the user of the connection between the two document objects 150 and to enable the user to view the first and second document objects 150 together again despite their updated positions in the virtual workspace 120. In short, the document-processing system 100 can move document objects 150 while maintaining useful connections, thus allowing the user to engage in complex analysis or to experiment with arrangements that might draw enlightening connections between annotations, excerpts, connections, or other aspects of a document 1700.

As also described above, a document object 150 can be grouped with one or more other document objects 150 such that groups of document objects 150 automatically remain together. For instance, when a user requests that a first document object 150 in a group be moved (e.g., by dragging that first document object 150 to a new position in the virtual workspace 120), then the document-processing system 100 can cause all of the document objects 150 in the group to move such that the spatial relationship among document objects 150 within the group is fixed. In some embodiments, the document-processing system 100 maintains groups even when automatically rearranging, or sorting, document objects 150 based on tag categories (i.e., categories of tags 520). In one example, for instance, when the document-processing system 100 automatically arranges the document objects 150, the document-processing system 100 positions the primary document object 150 of a group according to the tags 520 of that document object 150, and the remaining document objects 150 in the group maintain their spatial relationships to that primary document object 150. In another example, each document object 150 in the group can be automatically positioned based on its tags 520, and the document-processing system 100 can establish new references among the document objects 150 to represent the group. For instance, the document-processing system 100 can add a group link to each such document object 150; when the user selects the group link, the document-processing system 100 emphasizes all document objects 150 in the group, regardless of their current positions, or the document-processing system 100 temporarily shows the spatial relationship of the document objects, as grouped, responsive to the selection of the group link.

In the example of FIG. 7, each virtual grid cell, corresponding to a first value in the first category and a second value in the second category, has no more than a single document object 150. In other words, no document object 150 in the virtual workspace 120 shown shares values in both the first category and the second category with another document object 150. This need not be the case in certain embodiments. In some embodiments, the document-processing system 100 collects together the document objects 150 belonging to a single grid cell due to having common values in all the categories used to sort the document objects. For example, the document-processing system 100 can stack such document objects 150 atop one another. In that case, then the user selects the stack, the document-processing system 100 can cause the stacked document objects 150 to spread out to enable the user to see each document object in the grid cell simultaneously or to enable the user to select which of such document objects 150 to view. Various other techniques may be used to arrange document objects 150 in a common grid cell upon sorting.

Further, in the example of FIG. 7, the document objects 150 are arranged based on two categories and thus in two dimensions. In some embodiments, however, the document objects 150 may be arranged based on more than two categories and thus in more than two dimensions. Various techniques can be used to display more than two dimensions of document objects 150. For example, another dimension can be displayed in a z-direction that points into and out of the workspace in a perpendicular or close to perpendicular manner. In that case, planes of document objects 150 can be stacked atop one another, or placed beside one another, such that each plane represents a value in a third category, and such that each plane includes a two-dimensional grid of document objects 150 arranged according to the first category and the second category.

In some embodiments, a project view 510 (i.e., the arrangement of objects in the virtual workspace 120) is dynamic. For instance, if the document objects 150 are currently in an automatically arranged position, as in the example of FIG. 7, and if the user modifies a document object 150 to change a tag in the first category from a first value to a second value, the document-processing system 100 may automatically reposition the document object 150 based on its updated tag 520. In other words, if the first category is distributed over the horizontal axis, then a change in the tag for the first category may cause the document-processing system 100 to change the horizontal position (e.g., the x-coordinate) of the document object 150 so as to align the document object 150 with a horizontal position (e.g., a range of horizontal positions) associated with the second value for the first category.

In some embodiments, however, the project view 510 does not automatically update due to a change in tags of document objects 150. In that case, the user can maintain the current project view 510 of the document objects 150 while continuing to make manual changes based on that project view 510 to update the project view 510 manually. In still other embodiments, the document-processing system 100 enables the user to indicate whether the project view 510 should update automatically based on a change in tags.

In some embodiments, after the document objects 150 are arranged automatically, as shown in the example of FIG. 7, the document-processing system 100 enables the user to make further modifications, manual or automated, to the placements of document objects 150 in the virtual workspace 120. For instance, the document-processing system 100 can enable manual rearrangement even after an automated arrangement. Thus, the user can request (e.g., by touching and dragging a first document object 150) that the document-processing system 100 reposition a first document object 150 after an automated arrangement of document objects 150 based on categories. In that case, the document-processing system 100 can maintain other document objects 150 in their current positions while repositioning the first document object 150 based on the user's request. In some further embodiments, if a second document object 150 is grouped with the first document object 150, the document-processing system 100 can reposition that second document object 150 as well to maintain the spatial relationship between the first document object 150 and the second document object 150. As a result, the user can utilize an automated arrangement of document objects 150 to provide insights or organization and, further, can make manual adjustment as desired to find additional connections and relationships between information displayed in the virtual workspace 120.

In some embodiments, the document-processing system 100 enables the user to save a project view 510 of a project 101. Each project view 510 corresponds to a specific arrangement of document objects 150 or other aspects in the GUI 102, such as in the virtual workspace 120. That arrangement could have been manually or automatically formed, such as in the manner described herein. In some embodiments, the document-processing system 100 enables the user to switch between project views 510, which can automatically rearrange the document objects 150 according to a project view 510 when a project view 510 becomes active (e.g., is selected by a user). For instance, a user requests a particular project view 510, such as by choosing a pre-saved project view 510 from a drop-down box or other input mechanism. Based on this request, the document-processing system 100 automatically rearranges the document objects 150 in the virtual workspace 120 to match the arrangement saved in the project view 510.

The project views 510 of the document-processing system 100 provide various benefits. For instance, each project view 510 can emphasize different relationships among or between document objects 150 or among or between document objects 150 and one or more documents 170. As such, each project view 510 can assist a user in active reading in various ways. Further, when a project 101 is shared among multiple users, each user may have different preferred project views 510, and each user can use that user's preferred project views 510 to analyze the document 170. Additionally or alternatively, a user may find that a project view 510 created at the request of a different user provides new insights and could even be useful in unexpected ways.

When the user seeks to exit the document-processing system 100 but would like to retain the state of the project 101, the document-processing system 100 can enable the user to save the current state of the project 101, which can include tags, categories, and project views 510, and which can further include document objects 150 or other aspects (e.g., the current state of the document 170 in the document view region 140 or the current state of the preview region 130) displayed in the virtual workspace 120. For example, the document-processing system 100 can be associated with a proprietary file format in which the document-processing system 100 can save the project 101 in the storage 111. For another example, the document-processing system 100 can export a project view 510 of the virtual workspace 120 by printing to paper, printing to Adobe PDF, or saving to an image.

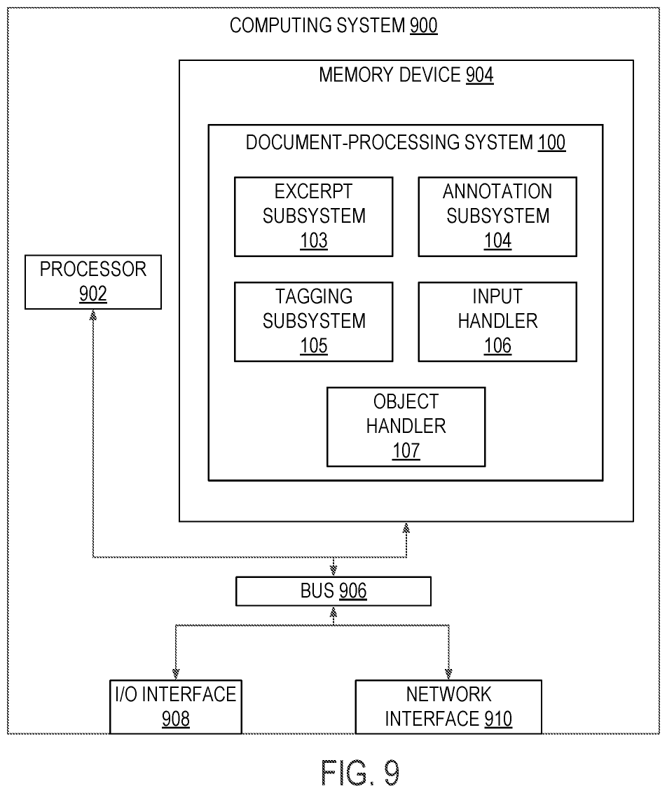

FIG. 9 is a diagram of an example of a computing system 900 that can perform certain operations described herein, according to some embodiments described herein. For instance, this computing system 900 can be an instance of the computing system 110 shown in FIG. 1. Various suitable computing systems or groups of computing systems can be used for performing the operations described herein. For example, FIG. 9 depicts an example of a computing system 900 that executes the document-processing system 100, including the excerpt subsystem 103, the annotation subsystem 104, and tagging subsystem 105, and the object handler 107. In other embodiments, as in the example of FIG. 9, a separate computing system having devices similar to those depicted in FIG. 9 (e.g., a processor, a memory, etc.) executes one or more subsystems of the document-processing system 100 and is in communication with the computing system 900 for operation of the document-processing system 100.

The depicted example of the computing system 900 includes a processor 902 communicatively coupled to one or more memory devices 904. The processor 902 executes computer-executable program code stored in a memory device 904, accesses information stored in the memory device 904, or both. Examples of the processor 902 include a microprocessor, an application-specific integrated circuit (“ASIC”), a field-programmable gate array (“FPGA”), or another suitable processing device. The processor 902 can include one or more processing devices, such as a single processing device.

The memory device 904 includes a suitable non-transitory computer-readable medium for storing data, program code, or both. A computer-readable medium can include an electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or another medium from which a processing device can read instructions. The instructions may include processor-specific instructions generated by a compiler or an interpreter from code written in a suitable computer-programming language, including, for example, C, C++, C#, Visual Basic, Java, Python, Perl, JavaScript, or ActionScript.

The computing system 900 may also include a number of external or internal devices, such as input or output devices. For example, the computing system 900 is shown with one or more input/output (“I/O”) interfaces 908. An I/O interface 908 can receive input from input devices 113 or provide output to output devices 112; for instance, a multi-touch input device may communicate with the computing system 900 via the I/O interface 908 and may thereby enable a user to utilize the document-processing system 100. One or more buses 906 are also included in the computing system 900. The bus 906 communicatively couples one or more components of a respective one of the computing system 900.

The computing system 900 executes program code that configures the processor 902 to perform one or more of the operations described herein. The program code includes, for example, instructions for implementing the excerpt subsystem 103, the annotation subsystem 104, the tagging subsystem 105, the object handler 107, or other suitable systems that perform one or more operations described herein. The program code may be resident in the memory device 904 or a suitable computer-readable medium and may be executed by the processor 902 or other suitable processor.

An embodiment of the computing system 900 also includes a network interface device 910. The network interface device 910 includes a device or group of devices suitable for establishing a wired or wireless data connection to one or more data networks. Non-limiting examples of the network interface device 910 include an Ethernet network adapter, a modem, and the like. The computing system 900 is able to communicate with one or more other computing devices via a data network using the network interface device 910. For example, if the document-processing system 100 is operating in a cloud as a cloud service, then the computing system 900 can use the network interface device 910 to communicate with a consumer device or other device being operated by a user.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

The features discussed herein are not limited to a particular hardware architecture or configuration. A computing system, such as a computing device, can include a suitable arrangement of components that provide a result conditioned on one or more inputs. Suitable computing devices include multipurpose microprocessor-based computer devices accessing stored software (e.g., computer-readable instructions stored in a memory) that programs or configures the computing device from a general-purpose computing apparatus to a specialized computing apparatus implementing one or more aspects of the present subject matter. A suitable programming, scripting, or other type of language or combinations of languages can be used to implement the teachings contained herein in software to be used in programming or configuring a computing device.

Aspects of the methods disclosed herein may be performed in the operation of such computing devices. The order of the blocks presented in the method examples above can be varied; for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Accordingly, it should be understood that the present disclosure has been presented for purposes of example rather than limitation and does not preclude inclusion of such modifications, variations, or additions to the present subject matter as would be readily apparent to one of ordinary skill in the art.

What is claimed is:

1. A method comprising:
accessing a virtual workspace comprising a document and document objects associated with the document, wherein each document object of the document objects relates to a respective portion of the document;
tagging a document object of the document objects with a tag comprising a first value selected from a first category of values;
receiving a request for an automated arrangement of the document objects by the first category;
assigning to the document object a first coordinate in a dimension of the virtual workspace, wherein the first coordinate is computed based on the first value in the first category; and
automatically repositioning the document object within the virtual workspace to the first coordinate in the dimension, based on the request.

2. The method of claim 1, further comprising generating the document object to include an excerpt of the respective portion of the document.

3. The method of claim 1, further comprising generating the document object to include an annotation related to the respective portion of the document.

4. The method of claim 1, wherein the tag further comprises a second value selected from a second category of values, and wherein the method further comprises:
assigning to the document object a second coordinate in a second dimension of the virtual workspace, wherein the second coordinate is based on the second value in the second category;
wherein automatically repositioning the document object within the virtual workspace further comprises positioning the document object to the second coordinate in the second dimension.

5. The method of claim 4, wherein the second category represents at least one of creation times or modification times of the document objects, and wherein the second value comprises at least one of the creation time or modification time of the document object.

6. The method of claim 4, wherein the tag further comprises a third value selected from a third category of values, and wherein the method further comprises:
assigning to the document object a third coordinate in a third dimension, wherein the third coordinate is based on the third value in the third category;
wherein automatically repositioning the document object based on the request further comprises positioning the document object to the third coordinate in the third dimension.

7. The method of claim 1, further comprising:
receiving an update to the document object changing the first value in the first category to a second value in the first category; and
automatically repositioning the document object from the first coordinate in the dimension to a second coordinate in the dimension, responsive to the change from the first value to the second value.

8. The method of claim 1, further comprising:
detecting a manual rearrangement of the document objects to respective updated positions within the virtual workspace;
recalling the automated arrangement of the document objects within the virtual workspace by automatically returning the document objects to their respective positions according to the automated arrangement; and
recalling the manual rearrangement of the document objects within the virtual workspace by automatically returning the document objects to their respective positions according to the manual rearrangement.

9. The method of claim 1, further comprising:
tagging a second document object of the document objects with a second tag comprising a second value selected from the first category of values, wherein the second value is distinct from the first value;
assigning to the second document object a second coordinate in the dimension of the virtual workspace, wherein the second coordinate is based on the second value and is distinct from the first value; and
automatically repositioning the second document object within the virtual workspace to the second coordinate in the dimension, based on the request.

10. The method of claim 1, further comprising:
determining that a second tag of a second document object of the document objects lacks an assignment in the first category;
determining, based on values of other tags of the document objects, a second value in the first category for the second document object;
assigning to the second document object a second coordinate in the dimension, wherein the second coordinate is based on the second value; and
automatically repositioning the second document object within the virtual workspace to the second coordinate in the dimension, based on the request.

11. A computer-program product comprising a computer-readable storage medium having program instructions embodied thereon, the program instructions executable by a processor to cause the processor to perform a method comprising:
accessing a project comprising a document and document objects positioned in a virtual workspace;
generating a document object relating to a portion of the document, the document object positioned at an initial position in the virtual workspace;
tagging the document object with a tag comprising a first value selected from a first category associated with the project and further comprising a second value selected from a second category associated with the project;
receiving a request for an automated arrangement of the document objects by the first category and the second category;
computing a first coordinate for the document object based on the first value of the tag;
computing a second coordinate for the document object based on the second value of the tag; and
automatically repositioning the document object within the virtual workspace to an updated position comprising the first coordinate in a first dimension and the second coordinate in a second dimension, based on the request to arrange the document objects by the first category and the second category.

12. The computer-program product of claim 11, wherein the document object comprises a referral link referencing the portion of the document, and wherein the method further comprises:
detecting a selection of the referral link while the document object is in the initial position;
updating a view of the document to highlight the portion of the document responsive to the selection of the referral link while the document object is in the initial position;
detecting another selection of the referral link while the document object is in the updated position; and
updating a view of the document to highlight the portion of the document responsive to the selection of the referral link while the document object is in the updated position.

13. The method of claim 11, wherein the tag further comprises a third value selected from a third category associated with the project, and wherein the method further comprises:
computing a third coordinate for the document object based on the third value of the tag;
wherein the updated position comprises the third coordinate in a third dimension.

14. The computer-program product of claim 11, the method further comprising:
receiving an update to the document object changing the first value in the first category to an other value in the first category; and
automatically repositioning the document object from the first coordinate in the first dimension to another coordinate in the dimension, responsive to the change from the first value to the other value.

15. The computer-program product of claim 11, the method further comprising:
saving into the project the automated arrangement of the document objects;
detecting a manual rearrangement of the document objects to respective updated positions within the virtual workspace;
saving into the project the manual rearrangement of the document objects;
receiving a request to recall a saved arrangement of the document objects; and
repositioning one or more of the document objects according to the saved arrangement, based on the request to recall the saved arrangement.

16. A method comprising:
receiving an indication of a touch-based gesture provided via manual input, wherein the touch-based gesture relates to a portion of a document displayed in a virtual workspace;
mapping the touch-based gesture to a request to generate a document object;
generating the document object in the virtual workspace, wherein the document object comprises a referral link to the portion of the document, based on the request to generate the document object;
tagging the document object with a tag comprising a respective first value selected from a first category and a respective second value selected from a second category;
tagging an additional document object with an additional tag comprising a respective first value selected from the first category and a respective second value selected from the second category;
receiving an indication of an additional touch-based gesture provided via manual input;
mapping the additional touch-based gesture to a request to automatically arrange document objects in the workspace by the first category and the second category;
automatically repositioning the document object within the virtual workspace to a position having a respective first coordinate computed based on the respective first value of the tag and having a respective second coordinate computed based on the respective second value of the tag; and
automatically repositioning the additional document object within the virtual workspace to an additional position having a respective first coordinate computed based on the respective first value of the additional tag and having a respective second coordinate computed based on the respective second value of the additional tag.

17. The method of claim 16, wherein the document object comprises at least one of an excerpt of the portion of the document or an annotation to the portion of the document.

18. The method of claim 16, wherein the first category represents at least one of creation times or modification times of the document objects, and wherein the respective first value of the tag comprises at least one of the creation time or modification time of the document object.

19. The method of claim 16, further comprising:
receiving an update to the document object changing the respective first value of the tag to another value selected from the first category; and
automatically repositioning the document object from the position to an updated position having an updated coordinate in a dimension corresponding to the first category.

20. The method of claim 16, further comprising:
saving an automated arrangement of the document objects within the virtual workspace;
detecting a manual rearrangement of the document objects to respective updated positions within the virtual workspace; and
recalling the automated arrangement of the document objects within the virtual workspace by automatically returning the document objects to their respective positions according to the automated arrangement.
